(19) United States
(12) Patent Application Publication
(10) Pub. No.: US 2004/0243261 A1
(43) Pub. Date: Dec. 2, 2004

(54) System and method for capturing and analyzing tennis player performances and tendencies

(76) Inventor: Brian King, Ft. Lauderdale, FL (US)

Correspondence Address: Kerry Sisselman, Concord Camera Corp., 4000 Hollywood Blvd., Suite 650N, Hollywood, FL, 33021, US

(21) Appl. No.: 10/714,308

(22) Filed: Nov. 13, 2003

Related U.S. Application Data
(60) Provisional application No. 60/414,529, filed on Nov. 13, 2002.

(51) Int. Cl. G06F 155/00

(52) U.S. Cl. 700/91

(57) ABSTRACT

A system and method for capturing and analyzing data from a tennis match and converting the data into a representation of the player's performances and tendencies. The system includes means for capturing data related to a player's performance during a tennis match. In one particular embodiment, the means for capturing data includes a video camera, structured to capture one or more tennis players on the court during a match. In another embodiment the data is captured manually. The system further includes a means for analyzing and manipulating the captured data to determine performance and tendency characteristics. The manipulated data can then be provided in certain predetermined graphical, statistical or descriptive formats which demonstrate the player's tendencies with respect to the locations that he or she hits the ball for different types of shots and the results in each location for each type of shot.

### PRIORITY

The present application claims priority from co-pending provisional patent application Ser. No. 60/414,529, Filed on Nov. 13, 2002, entitled SYSTEM AND METHOD FOR CAPTURING AND ANALYZING TENNIS PLAYER PERFORMANCES AND TENDENCIES.

### FIELD OF THE INVENTION

The present invention relates in general to the field of statistical analysis and, more particularly, to a system and method for capturing and analyzing data related to tennis player performances to create graphical, statistical and descriptive representations of player performances and tendencies.

### BACKGROUND OF THE INVENTION

In today's information age, there is a general desire to gather as much data as possible. This thirst for data has extended into virtually all types of sporting events, where there is a constant desire to accumulate and disseminate as much information as possible. It is not uncommon these days to find publications setting forth player statistics for most major sports, such as baseball, football, golf and tennis.

In tennis, player statistics are often used by broadcast networks as part of their presentation of a match. However, the statistics currently being presented by the networks are general performance-type statistics which many viewers don't understand and which have little value. For instance, during a typical tennis match, the broadcast networks will present statistics on:

1. First serve winners and aces;

2. Break points converted; and

3. Total unforced errors and winners.

Although these statistics may be of some interest to the general sports enthusiast, they provide little value to most viewers or even the players themselves. The applicant, a tennis player and enthusiast, has discovered the need for a different approach to provide more meaningful information, an approach which will give the tennis audience more insight into the player's performances and tendencies and will enable the players themselves to better understand their opponent's, as well as their own, tendencies under different variable circumstances that might occur during a match.

Accordingly, there is still a need in the art for the system and method of capturing and analyzing tennis performance data and presenting such data in graphical, statistical and descriptive manners. Any such system should give the tennis audience insight into the player's performances and tendencies and allow players to analyze, understand and improve theirs, and their opponents performance and tendencies during different situations to gain any edge possible over their opponents. The present invention is particularly suited to overcome those problems which remain in the art in a manner not previously known.

### SUMMARY OF THE INVENTION

The present invention is directed towards a new and improved system and method for capturing and analyzing data from a tennis match and converting the data into graphical, statistical and/or descriptive representations of the player's performances and tendencies. Data relating to the performance of one or more players is captured and analyzed for performance statistics and tendency characteristics.

In one particular embodiment, the system includes means for capturing data related to a player's performance during a tennis match comprising at least one video camera, structured to capture one or more tennis players on the court during a match, disposed at fixed locations relative to the tennis court, means for analyzing and manipulating the captured data to measure and quantify certain predetermined performance and tendency characteristics comprising a computer system structured to receive the captured video signals from the video cameras and data processing software structured to quantify certain predetermined player performance characteristics from the captured video, and means for presenting the manipulated data in certain predetermined graphical, statistical or descriptive formats which demonstrate the player's tendencies with respect to the locations that he or she hits the ball for different types of shots and the results in each location for each type of shot.

In another embodiment, data is manually captured by the use of a computing device. In one particular embodiment, a personal digital assistant or handheld computer is used to manually enter data. Software (either hosted on the data collection unit or on a computer to which the data collection unit communicates) is used to analyze the data collected by the entry unit and to output performance statistics and tendency characteristics.

Additionally, as will be described in connection with various embodiments of the present invention, the system and method described may present the data in graphical, statistical and/or descriptive forms.

It is an object of the present invention to provide a new and improved system and method of capturing and analyzing tennis performance data which has all the advantages of the prior art devices and none of the disadvantages.

It is another object of the present invention to provide a such a system and method which gives the tennis audience insight into the player's performances and tendencies, i.e. consistency, effectiveness and results.

It is also an object of the present invention to provide such a system and method which allows players to analyze, understand and improve theirs, and their opponents performance and tendencies and patterns during different match situations.

It is yet another object of the present invention to provide such a system and method which can transmit the data to users with electronic handheld devices in attendance at a tennis match so that they can receive insightful information on the player's that they are watching.

These and other objects and advantages of the present invention will become more readily apparent in the description which follows.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings an exemplary embodiment that is presently preferred, it being understood however, that the invention is not limited to the specific methods and instrumentality's disclosed. Additionally, like reference numerals represent like items throughout the drawings. In the drawings:

FIG. 1 is a top view illustrating a field of play equipped with the main components of one embodiment of the present invention.

FIG. 2 illustrates a sample main menu and selection tool used with an exemplary device useful with one embodiment of the present invention.

FIG. 3 illustrates a sample data entry screen and tool useful with one embodiment of the present invention.

FIG. 4 illustrates a sample statistics options menu screen useful with one embodiment of the present invention.

FIG. 5 illustrates another sample statistics options menu screen useful with one embodiment of the present invention.

FIG. 6 illustrates a quantified statistics screen showing the data in graphical, statistical and descriptive forms useful with one embodiment of the present invention.

FIG. 7A is a top elevational view of a field of play divided into quadrants in accordance with one embodiment of the present invention.

FIG. 7B is a top elevational view of a field of play divided into quadrants in accordance with another embodiment of the present invention.

FIG. 8 is a top elevational view of a field of play divided into quadrants in accordance with one embodiment of the present invention.

FIG. 9 illustrates exemplary devices that may be used with the present invention.

### DETAILED DESCRIPTION OF THE PREFERRED EMBODIMENTS

Before explaining the disclosed embodiment of the present invention in detail, it is to be understood that the invention is not limited in its application to the details of the particular arrangement shown since the invention is capable of other embodiments. Also, the terminology used herein is for the purpose of description and not of limitation.

The present invention is directed towards a new and improved system and method for capturing and analyzing data from a tennis match and converting the data into graphical, statistical and/or descriptive representations of the player's performances and tendencies. The system comprises means for capturing data related to a player's performance during a tennis match, means for analyzing and manipulating the captured data to measure and quantify certain predetermined performance and tendency characteristics and means for presenting the manipulated data in certain predetermined graphical, statistical or descriptive formats.

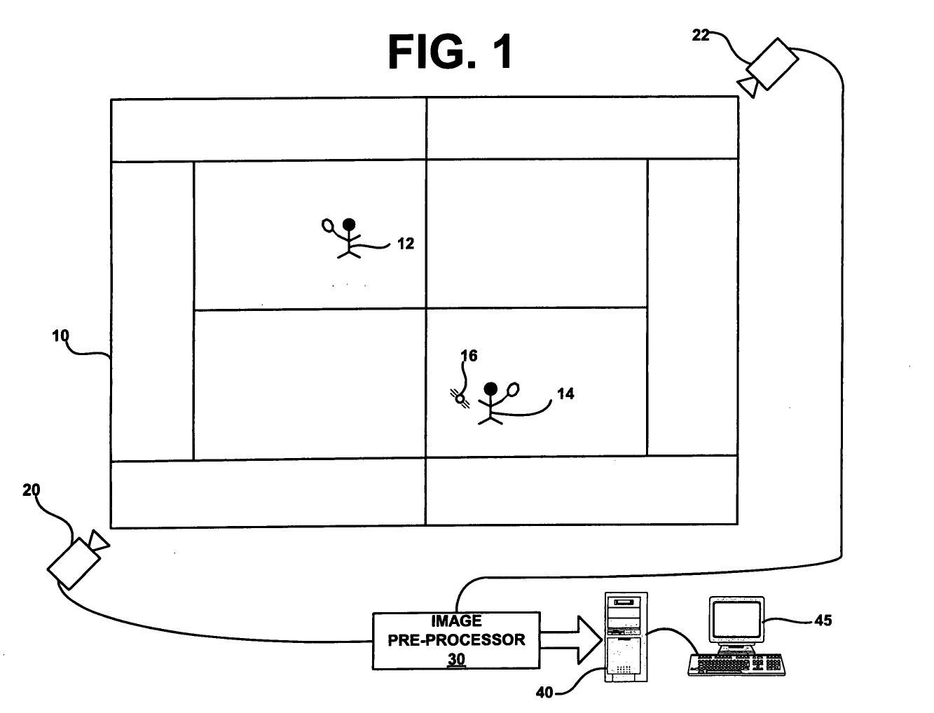

Referring now to FIG. 1, there is shown a first preferred embodiment of the present invention. A tennis court 10 is monitored by a video camera 20, which captures data related to a player's performance during tennis matches. Video camera 20 may be disposed at a fixed location relative to the tennis court 10, or otherwise may be movable by a camera person in order to better follow the action on the court. Optionally, a second video camera 22 or other additional cameras may be provided.

The video cameras 20,22 are structured to capture one or more tennis players 12,14 on the court during a match. Additionally, the interaction between the players and the game ball 16, and the surface of the court 10 and the game ball 16. The video cameras 20, 22 may be disposed above the court 10, facing downwards, to capture the match from an aerial view or beyond the end of the court 10 or the baseline, facing towards the court, to capture the match from an end or rear view. It should be appreciated that the video camera or cameras may, alternatively, be positioned at any other location relative to the court where a player or players can be captured.

The means for analyzing and manipulating the captured data to measure and quantify certain predetermined performance and tendency characteristics comprises a computer system 40, 45 coupled to the video cameras 20, 22 via a video pre-processing circuit 30 (which may additionally reside inside the computer 40) and data processing software residing on the computer system 40. The computer system 40 is structured to receive the captured video signals from the video cameras 20, 22 and the software is structured to quantify certain predetermined player performance characteristics from the captured video.

The video obtained by the cameras 20, 22, may be processed to determine the ball location, the player locations, the ball's interaction with each player and the ball's interaction with the surface of the court as shown in any of U.S. Pat. Nos. 6,072,504, 6,141,041, 6,233,007 and 6,441,846, those patents incorporated herein by reference. Alternatively, the video data from a single camera 20 or multiple cameras can be processed as known in the art to determine the ball and player locations, interactions and other performance characteristics.

The software should be programmed with the rules of the game of tennis such that certain performance characteristics may be determined by the computer 40 in response to the data generated from the captured video. If desired, certain performance characters may be manually entered into the computer 40 on the terminal 45 by a data entry person observing the match in real time, or reviewing the tennis match off-line. Examples of some of the performance characteristics quantified by the computer 40 are generally related to a combination of the following:

1. the type of shot, including, but not limited to:

(i) first serve

(ii) second serve

(iii) service return

(iv) forehand

(v) backhand

(vi) drop shot

(vii) approach shot

(viii) overhead

(ix) forehand volley

(x) backhand volley

2. the location of the shot, including, but not limited to:

(i) cross court

(ii) down the line

(iii) down the middle

(iv) to opponent's forehand

(v) to opponent's backhand

(vi) deuce court

(vii) add court

3. the result of the shot, including, but are not limited to:

(i) ball kept in play by opponent

(ii) unforced error

(iii) winner

(iv) ball returned for winner by opponent

(v) ace

(vii) fault

It should be appreciated that the above lists are only examples of types of shots, locations and results and that any other types may also be tracked.

To further elaborate, examples of the combinations of the above listed characteristics which may be measured and quantified include:

Service Characteristics

1. first/second serves to opponent's forehand/backhand in the deuce/add court kept in play by opponent;

2. first/second serve winners to opponent's forehand/backhand in the deuce/add court;

3. first/second serves to opponent's forehand/backhand in the deuce/add court returned for winner by opponent;

4. first/second serve aces to opponent's forehand/backhand in the deuce/add court;

5. first/second serve faults to opponent's forehand/backhand in the deuce/add court;

Return Characteristics

1. first/second serves to forehand/backhand in deuce/add court returned down the line/cross court and kept in play by opponent;

2. first/second serves to forehand/backhand in deuce/add court returned down the line/cross court for winners;

3. unforced errors from first/second serve returns to forehand/backhand in deuce/add court returned down the line/cross court;

Rally Characteristics

1. forehands/backhands cross court/down the line kept in play by opponent;

2. forehand/backhand cross court/down the line winners;

3. forehands/backhands cross court/down the line unforced errors;

4. forehands/backhands cross court/down the line returned for winner by opponent.

Again, it should be appreciated that the above combinations are only examples and that any other types may also be tracked.

The above characteristics may also be expanded to measure a player's performance and tendencies taking into account other variables and circumstances, such as:

1. daytime vs. evening;

2. indoors vs. outdoors;

3. court surface;

4. the particular game, set or match circumstance, i.e, player has game point or is facing a game point; and

5. length of the match;

The above characteristics and tendencies may be measured over and compared with any desired time period, such as (i) the players career, (ii) the last ten (10) matches or (iii) before and after an injury or other layoff. Using the above described system, data may be maintained and quantified relating to a player's tendencies. The captured data stored over time can be used to indicate to a player, a player's opponent or another interested party, the repetitive tendencies of a particular player. For example, by capturing and sorting data on every ball hit by a player, certain patterns will emerge. The patterns of play (tendencies) derived from the sorted data are used to evaluate the player's consistency, effectiveness and results.

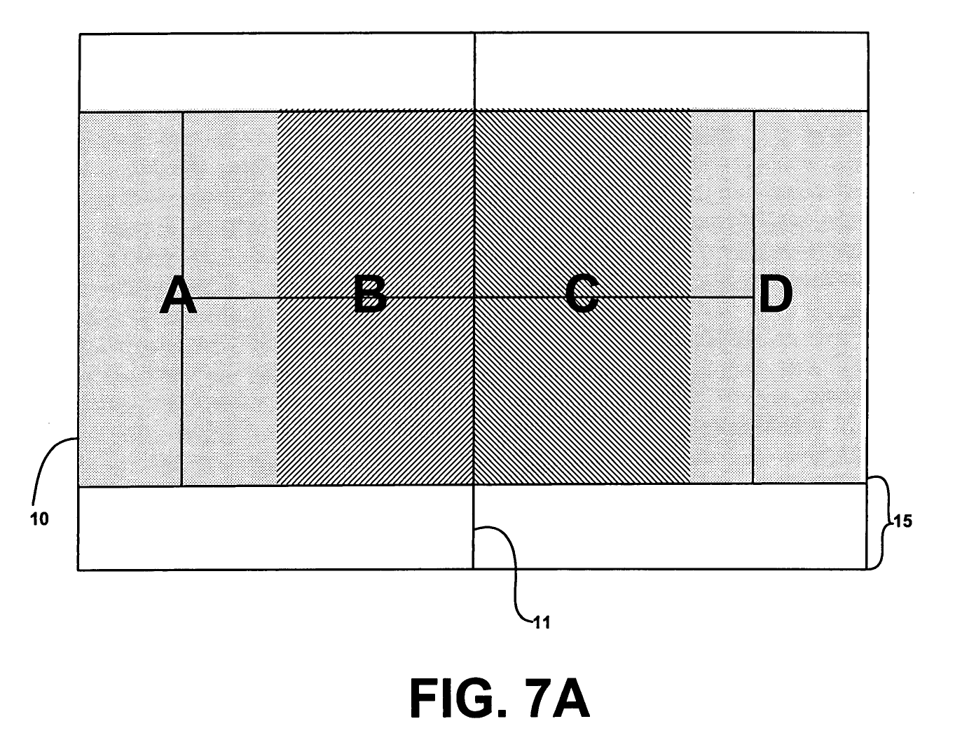

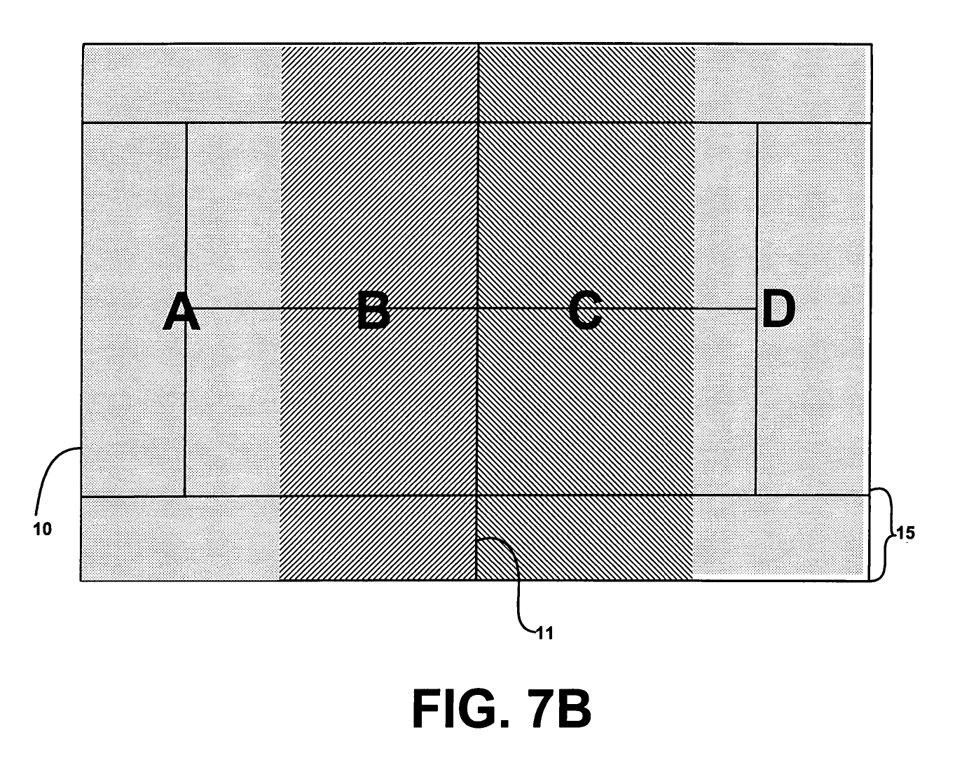

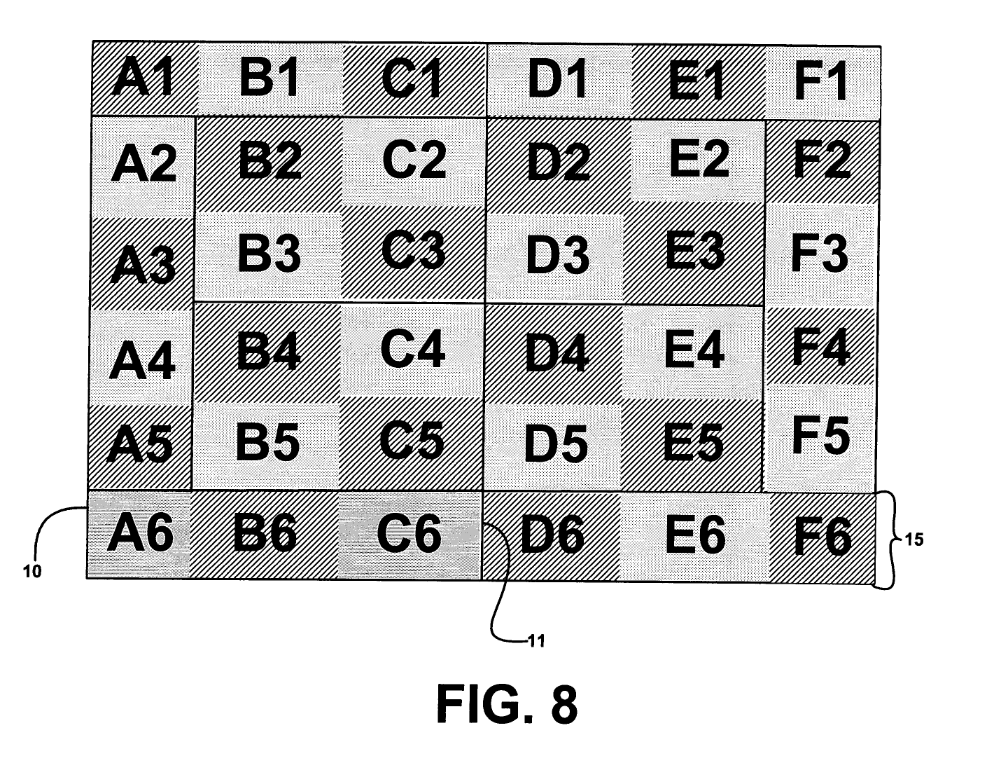

Referring now to FIGS. 7A, 7B and 8, it can be seen that the tennis court 10 can be broken down into a number of quadrants to which match data relates. More specifically, in the more generalized embodiment of FIGS. 7A and 7B, the court 10 is broken into four quadrants, with quadrants A and C on one side of the net 11 and quadrants B and D on the other side. The software is programmed to recognize that for singles games the alleys 15 (FIG. 7A) are out of bounds, but in doubles games the alleys are part of the respective quadrants (FIG. 7B). Often, it is desireable to have a greater number of quadrants. In FIG. 8, there is shown a tennis court 10, having a plurality of quadrants A, B, C, D, E and F, each of which has a plurality of zones 1-6. This permits the data analysis to finely focus the data relating to a player's tendencies. Note that the number of quadrants chosen in FIGS. 7A, 7B and 8 are exemplary, and fewer or greater numbers and/or shapes of quadrants for data analysis, may be chosen.

Data may be sorted by location in combination with other factors. For example, it may be desired to sort the data showing all balls hit during a particular match by a first player from quadrant A (FIG. 7A), so as to examine the data to find patterns and tendencies. For example, if the graphic shows that the of the last ten balls theplayer hit from quadrant A, eight of the ten balls landed in quadrant D (FIG. 7A), one landed in quadrant C and one went out of bounds, an opponent studying such a graphic would know that when the player hits from quadrant A, statistically the opponent needs to return the ball from quadrant D. Additionally, the data may be manipulated further. Statistics on the opponent may be pulled up to determine statistically how many balls in the past the opponent successfully returned from quadrant D or how many of the successfully returned balls were returned using backhand. It can be seen that by collecting this data, hundreds of data combinations can be analyzed to bring out patterns and tendencies in a player's game.

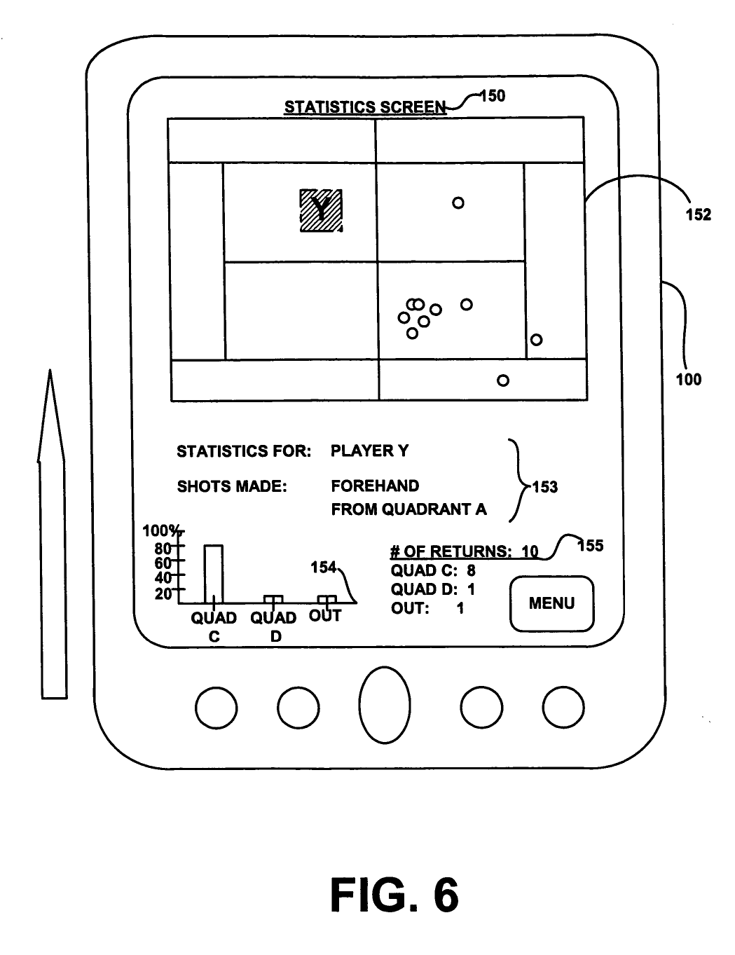

Other combinations of data can be analyzed to portray emerging tendencies. For example, if desired, location need not be selected. Rather, data relating to how often an opponent returned the second serve of a particular player, or of all players against whom the opponent played, may be generated. As will be shown more particularly in connection with FIG. 6, the analyzed data may be presented to the interested party graphically, statistically or in a textual or descriptive manner.

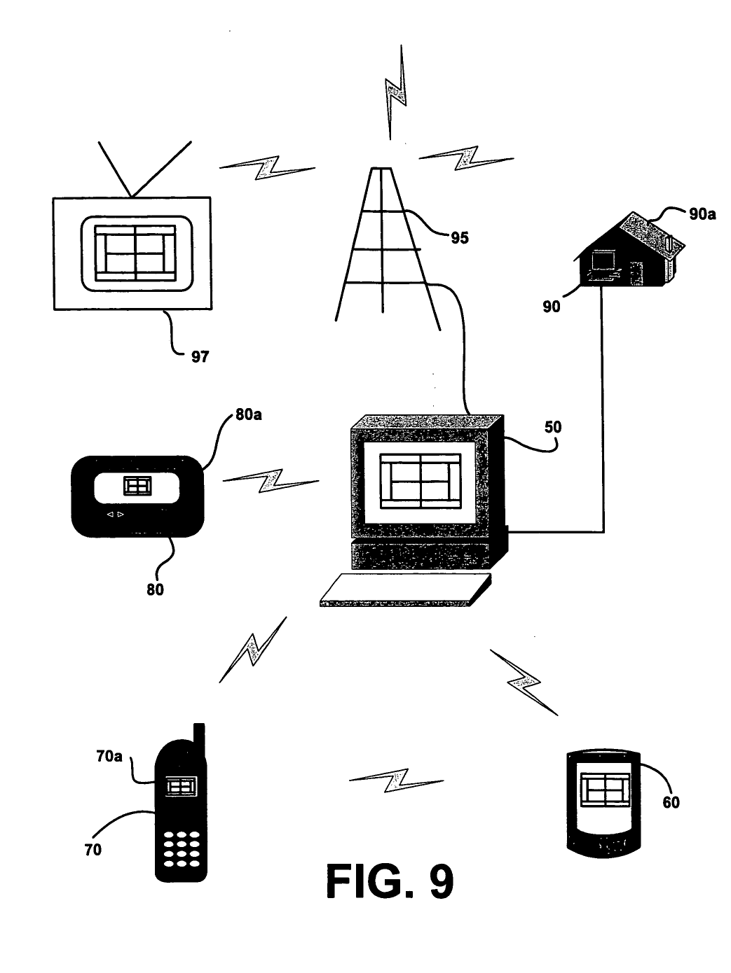

Further, the information generated by the computer 40 may be transmitted to a variety of devices. Referring to FIG. 9, there is shown a computer 50 and a variety of devices which may interact with the computer 50, or with each other. More particularly, computer 50 may gather and/or analyze the data, as does the computer 40 of FIG. 1a, or it may receive the raw or analyzed data from another device, such as the personal digital assistant (PDA) 60. The computer 50 may transmit the raw or analyzed data to other devices, wirelessly, such as by using a wireless network like WiFi or the BLUETOOTH standard introduced by Ericsson or using IR. Alternatively, the data may be transmitted by wired connection or landline to the ultimate destination. For example, the computer 50 may wirelessly transmit data to a satellite, cellular, PCS or GSM telephone 70 having a display 70a, or to a pager device 80 having a display 80a, such as the RIM device by BLACKBERRY. Further, a remote computer 90 located in a home or office 90a, could access the data by internet or direct connection, via a telephone connection, DSL line or cable modem. Additionally, graphical, statistical or textual displays may be generated by the computer 50, which are then transmitted via cable or uplink to a television or cable transmitter 95 for retransmission and display on the television set 97 of a remote viewer. Data may additionally be provided to a PDA device 60, by directly docking the PDA into a cradle attached to the computer 50, or wirelessly, if the PDA has that capability, such as the PALM Vii, by PALM INC. If desired, during a sporting match, the computer 50, may transmit the raw or analyzed data in the form of raw data or graphical, statistical and/or textual displays, to devices 60, 70 and 80, present locally in the sporting venue, so that those spectators have access to the data. Further, as will be described more particularly herebelow, the data may be gathered on a portable device, such as a PDA, laptop or handheld computer device, and analyzed on the portable device. The portable device may then transmit the raw or analyzed data directly to other devices, such as devices 50, 70 and 80.

In another preferred embodiment, the means for capturing data related to a player's performance during tennis matches comprises entering the data manually into the system. This may be accomplished using either (i) a standard computer keyboard or keypad on a handheld data entry device, such as a PDA, (ii) a touchscreen on a computer monitor or handheld data entry device, (iii) a customized computer keyboard or keypad on a handheld data entry device or (iv) or any other data entry means known in the art. The data may be entered into the above data entry devices by pressing keys, or areas of the touchscreen, representing the particular shot, location, result, or combination of shot, location and/or result, by touching a particular location on a touchscreen displaying the layout of a tennis court to indicate the type of shot, location and/or result, or by a combination of these methods.

The means for presenting the manipulated data in certain predetermined formats comprises either a (i) a graphical display of the data, (ii) a statistical presentation of the data or (iii) a descriptive presentation of the data. In the preferred embodiment, the graphical display comprises a graphical representation of a tennis court with indicia illustrating the player's tendencies with respect to the locations that he or she hits the ball for different types of shots and the results in each location for each type of shot. For instance, one display may show the tennis court with lines dividing the court into four equal sections and numbers or other indicia indicating (i) the percentage of forehands hit into each section, (ii) the percentage of those points won, (iii) the percentage of unforced errors when hitting forehands into each section or (iv) the percentage of forehands in each section returned for winners by the opponent. It should be appreciated that in presenting the graphical format, the manner in which the court may be sectioned, the types of data illustrated and the manner in which it is illustrated may be varied to present any desired data in virtually any desired manner.

In alternative preferred embodiments, the data may be presented in statistical or descriptive formats. The same data presented in the graphical format may be presented in either of these alternative formats. Additionally, the different formats may be combined in any desired manner to present the data in multiple formats simultaneously, i.e, graphically with statistical data and/or descriptive data.

The graphical, statistical and/or descriptive data may be displayed on a computer monitor, output in printed version, transmitted to a television audience or transmitted to handheld devices, such as PDAs, of users in attendance at a tennis match so that they can have insightful information on the players that they are watching. Additionally, users of the handheld devices to which the data is transmitted, users displaying the data on computer monitors, and even television viewers with interactive capabilities, may select which statistic, tendency, etc to be displayed.

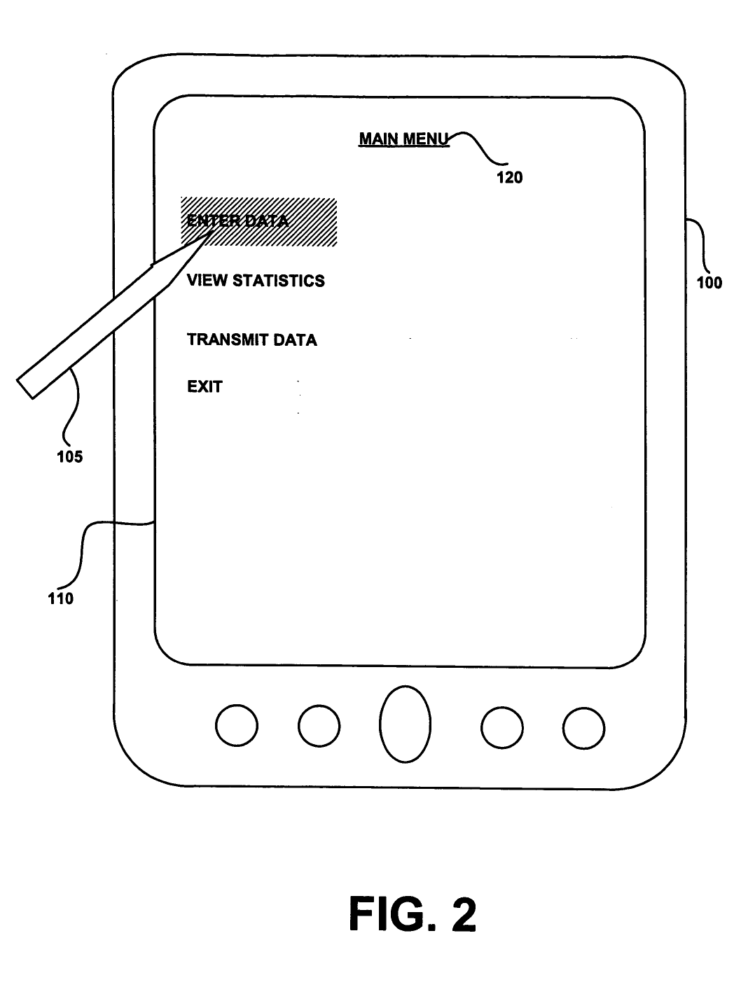

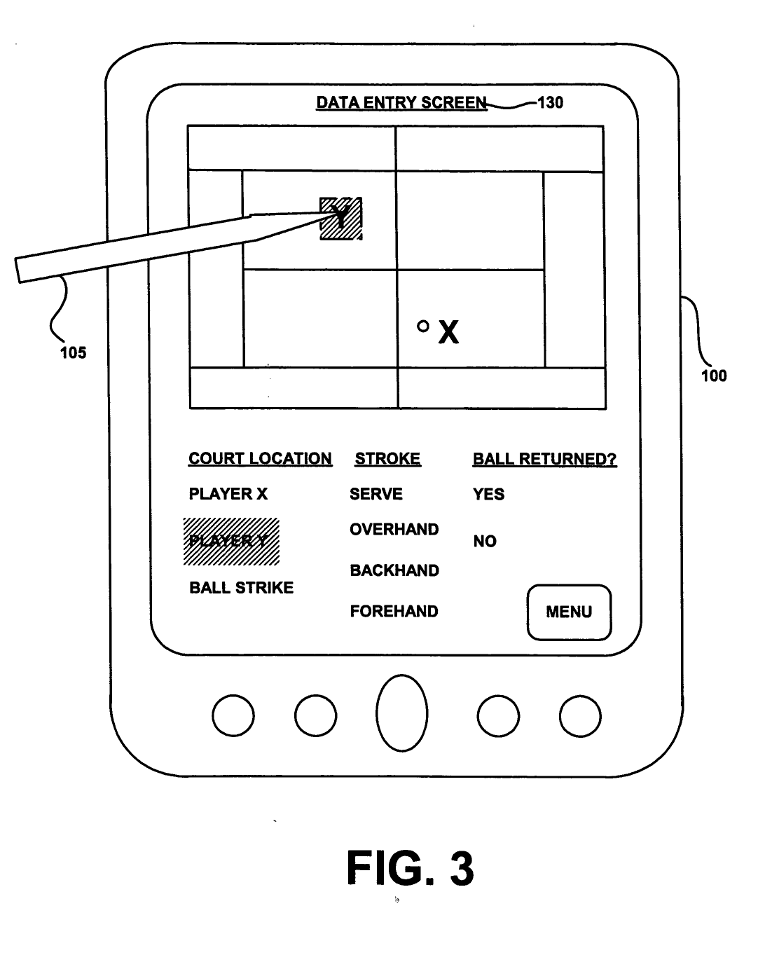

Referring now to FIGS. 2-8, there is shown one particular alternate preferred embodiment of the present invention. A handheld device 100, such as a PDA, is provided having a touch screen 110 actuated by a stylus 105. Software within the PDA provides an interface. In FIG. 2, there is shown a main menu screen 120 from which the mode of operation of the present statistical system may be chosen. In the present embodiment, the user is offered the choice of entering data, viewing statistics, transmitting data or exiting the program. These are only examples. Other menu choices may be offered from the main menu.

In the present embodiment, if the user chooses to enter data, a data entry screen 130 of FIG. 2, appears. In the present embodiment, a graphical representation of the court is presented. Using the stylus, for each shot the location of each player and the ball, and the type of stroke used by each player is entered. For example, for the first stroke of a point, the serving player (i.e. Player Y) is selected, then while Player Y is selected, the stylus is used to locate on the graphical representation of the court, from where Player Y served and that the stroke was a serve. Then the “Ball Strike” is selected, and the stylus is used to locate on the graphical representatio of the court, whereh the ball struck the court. Then “Player X” is chosen using the stylus, and Player X's position is placed on the graphical representation of the court. While Player X is still selected, the stylus is used to select whether the return stroke attempted was overhand, backhand or forehand. Then the user enters whether the ball was successfully returned. If the ball was not successfully returned, and “NO” was selected, the handheld device 100 knows to increment the score and present another blank data entry screen. Additionally, the handheld device 100 is programmed to record all of the ball and player data entered, including the data that Player X failed to return the ball successfully. This information can later be searched, for example, by searching for errors committed by Player X using forehand, or at the net.

If the ball was successfully returned, and “YES” was chosen, another blank data entry screen is present to the user without the score being incremented, and the data from the previous screen is entered into a database. It can be seen that the data is entered for each ball stroke, not just for point winning ball strokes. Each data entry screen that is entered and stored relates to a particular volley during the set. This means that a plurality of data entry screens or volleys may be related to, and stored in connection with,a single game point.

Additionally, because the software of the handheld device is programmed with the rules of tennis, the data is additionally linked in the database automatically with the present score for the point. A first data entry screen (not shown) can be used to enter in general data such as court surface type, whether the match is on an indoor or outdoor court, and time of day or lighting conditions. Additionally, the software may be streamlined to advance to the next data entry screen automatically if an out of bounds ball location is chosen, or to select the player stroke as “serve” if the last player ball was not returned. The data entry screen may be exited by selecting the “MENU” soft button with the stylus.

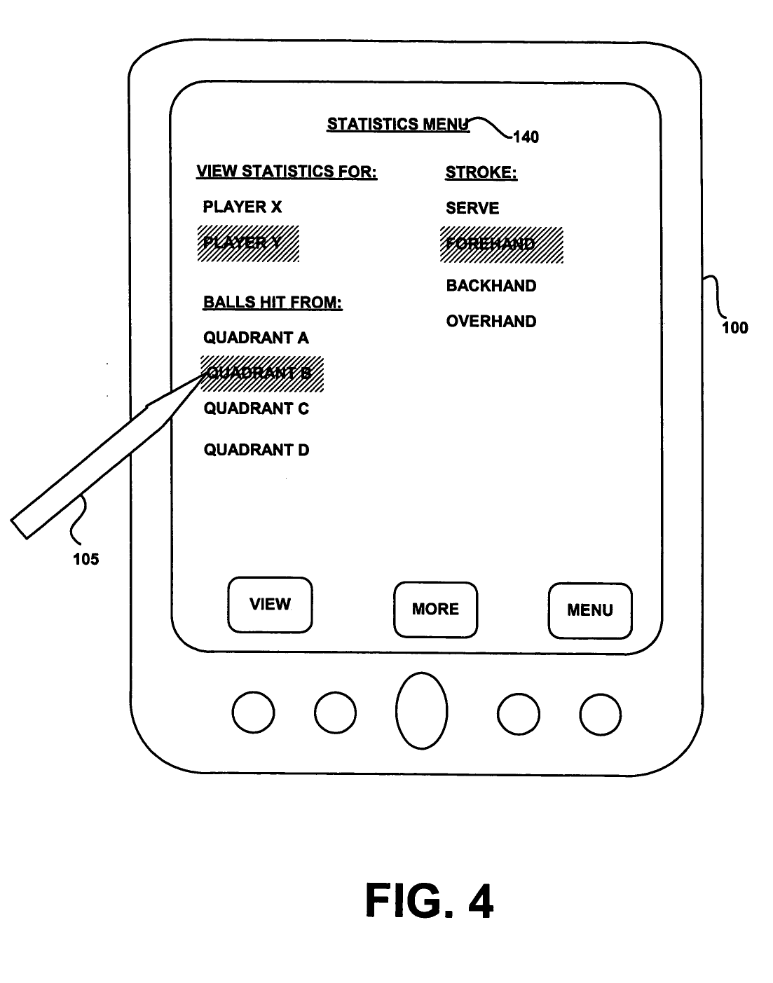

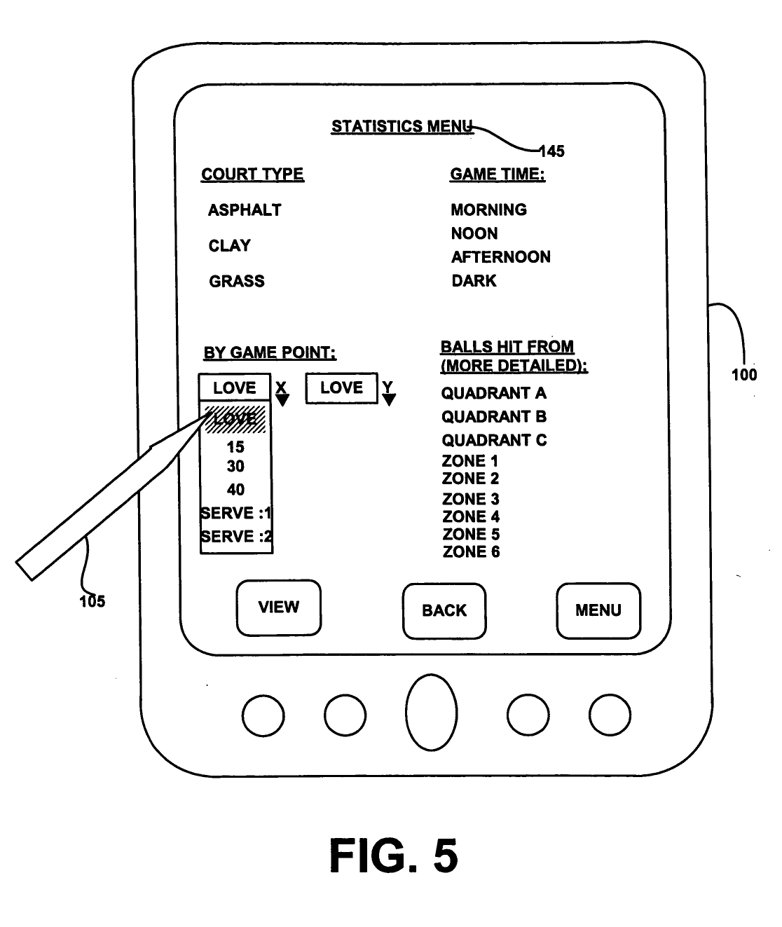

Once the data is accumulated in the database, it may be searched. A variety of choices for searching the data may be chosen. In the example of FIG. 4, a statistics menu 140 provides the user with a variety of options for sorting the data. In the example of FIG. 4, the user has selected to display statistics for balls hit by Player Y from Quadrant B (FIGS. 7A, 7B or 8) with a forehand stroke. When finished the user can select the “VIEW” soft button to view statistics fitting those sort criteria, or the “MORE” soft button to enter more sort criteria. The viewer may additionally return to the main menu. If “MORE” is selected, additional sort criteria screens, an example of which is shown as statistics menu 145 in FIG. 5, can be provided to the user. In FIG. 5, additional sort criteria include, court type, game time, by game score, and more detailed quadrant and zone locations corresponding to those quadrants (columns) and zones (rows) shown in FIG. 8. Additionally, drop down menus can be added, as shown, to provide more options.

Note that the more types of data that are entered into the database, the more types of search/sort criteria may be used to sort on the statistics menu. For example, the menu may be set up to permit the user to calculate the number of times the player won the point using a particular shot and/or from a particular location. To better streamline the entry of sort criteria, the sort pages should be arranged so that the most commonly requested criteria are presented on the first page, so that the user need not go to further sort criteria menu screens, if not necessary. Additionally, the software could have means for storing commonly requested sort queries. Further, if desired, the user could have the ability to reassign which sort criteria come up on which screens using the drag and drop technique, as is done when building database reports using MICROSOFT ACCESS. In this way statistical sorts can be performed more efficiently.

From any of the statistical menu screens, the user may view the data responsive to the sort criteria, may return to other statistics menu screens or may return to the main menu. Again, this is not meant to be limiting, as other choices may be included.

If “VIEW” is selected the sorted data is then presented to the user on a statistics screen 150 (FIG. 6). Data may be presented graphically, such as by showing the graphical representation of the court 152 and highlighting selected quadrant and/or zone from which the selected player hit the ball, and by graphically representing on the court, the resultant ball strike locations. In portion 153, the sort criteria is shown. Further, the data may be presented statistically as shown at 154, wherein the data is broken down by quadrant and percentage and/or descriptively, as shown at 155. Any combination of the methods of displaying the data may be chosen from an earlier statistics menu. From the statistics screen the user may return to other screens via the main menu.

Additionally, the raw data or analyzed data and/or statistics screens may be transmitted to another device (as shown in FIG. 9) from a transmit menu (not shown) using a wireless protocal such as WiFi or BLUETOOTH by Sony Ericsson, or by IR or may be transmitted over a wired connection to another device.

Note that although the present invention is described in connection with a tennis match, the invention can be adapted to record a single player's returns in response to various types of practice ball shots (i.e. lob, slice, etc.) hit by a pro or pitched by a machine. The system can be used to record all such returns, quantify the type of ball delivery shot and analyze the player's return tendencies. The patterns that emerge may be studied for informational purposes, such as an informational display sent to television viewers during a sports broadcast, or may be used by players or pros to correct emergent patterns in a player's game or predict patterns in an opponent's.

While the invention has been described, disclosed, illustrated and shown in various terms of certain embodiments or modifications, which it has presumed in practice, the scope of the invention is not intended to be, nor should it be deemed to be, limited thereby and such other modifications or embodiments as may be suggested by the teachings herein are particularly reserved, especially as they fall within the breadth and scope of the claims here appended.

What is claimed is:

1. A system for capturing and analyzing data from a tennis match to show player's tendencies, comprising:
a data collection unit for capturing data related to a player's performance during a tennis match;
a storage device for storing data captured by said data collection unit;
a computer system for analyzing and manipulating the stored data to determine player tendencies, said computer system including data processing software structured to sort said stored data by at least one specified sort criteria and generate a representation of said tendencies from at least a portion of said stored data that matches said specified sort criteria;
an operator interface in communication with said computer system for inputting said sort criteria; and
a display for presenting said representation to a viewer.

2. The system of claim 1, wherein said format is at least one of a predetermined graphical, statistical or descriptive format.

3. The system of claim 2, wherein said player tendencies relate to at least the location to which the player tends to hit the ball.

4. The system of claim 3, wherein said at least one sort criteria includes player's stroke type and one tendency shown relates to the results in each said location for each type of stroke.

5. The system of claim 3, wherein said data collection unit includes at least one video camera, structured to capture one or more tennis players on the court during a match.

6. The system of claim 3, wherein said data collection unit includes a mechanism for manually entering data into said data collection unit.

7. The system of claim 6, wherein said data collection unit further includes a touch screen for entering data.

8. The system of claim 7, wherein said data collection unit includes transmission means for transmitting data to another device.

9. A method for analyzing tennis player performance data to show player tendencies, comprising:
(a) dividing the tennis court into a plurality of discrete locations;
(b) acquiring at least one piece of data related to player performance on said tennis court and correlating said at least one piece of data to at least one of said discrete locations;
(c) storing said at least one piece of data in association with said at least one of said discrete locations;
(d) repeating steps (b) and (c) at least one time to accumulate a plurality of data;
(e) sorting said plurality of data by at least one sort criterion relative to at least one discrete location;
(f) displaying at least a portion of said data related to at least one discrete location.

10. The method of claim 9, wherein said portion of said stored data is presented in at least one of a graphical, a statistical and a descriptive format.

11. The method of claim 10, wherein said at least one sort criterion includes the type of stroke performed.

12. The method of claim 10, wherein at least one sort criteria includes the location from which a player hit the ball.

13. The method of claim 10, wherein said discrete location associated with said captured data relates to the location to which a player hit the ball.

14. The method of claim 13, further dividing each of said discrete locations into zones.

15. The method of claim 10, further including, (f) transmitting said at least a portion of said discrete data to a remote device.

16. A method for capturing and analyzing data from a tennis match to show player's tendencies, comprising:
collecting data related to a player's performance during a tennis match;
storing the collected data;
inputting at least one desired sort criteria;
manipulating the stored data pursuant to said sort criteria to obtain a subset of said collected data;
generating a representation of said subset;
displaying said representation to a viewer; and
analyzing said subset to determine a player's tendencies.

17. The method of claim 16, wherein the player's tendencies relate to at least the location to which the player tends to hit the ball.

18. The method of claim 17, wherein said at least one sort criteria includes player's stroke type and one tendency shown relates to the results in each said location for each type of stroke.

19. The method of claim 17, wherein said at least one sort criteria includes game point.

20. The method of claim 18, wherein said data collection unit includes a mechanism for manually entering data into said data collection unit.
